(19) United States
(12) Patent Application Publication
(10) Pub. No.: US 2025/0378434 A1
(43) Pub. Date: Dec. 11, 2025

(54) PROXIMITY-BASED CREDENTIAL VALIDATION

(71) Applicant: Apple Inc., Cupertino, CA (US)

(72) Inventors: Sunil NAIR, Fremont, CA (US); Alexander D. PELLETIER, Sunnyvale, CA (US); Eric T. YORK, Cupertino, CA (US); Haomin CUI, Apex, NC (US); Jason T. MILLER, San Jose, CA (US); Rahul Narayan SINGH, Santa Clara, CA (US); Venkata S. AKELLA, San Ramon, CA (US)

(21) Appl. No.: 18/796,236

(22) Filed: Aug. 6, 2024

Related U.S. Application Data
(60) Provisional application No. 63/657,730, filed on Jun. 7, 2024.

(51) Int. Cl. G06Q 20/38; G06Q 20/20

(52) U.S. Cl. CPC G06Q 20/36; G06Q 20/206; G06Q 20/3821

(57) ABSTRACT

The subject system may be implemented by a processor circuit configured to receive, by a digital wallet on the electronic device and from a provider server via an intermediate server, a digital credential, receive, via a near-field communication (NFC) component of the electronic device and from a physical credential corresponding to the digital credential, credential information associated with the physical credential, transmit, by the digital wallet on the electronic device and to the provider server via the intermediate server, the credential information to verify the credential information, receive, by the digital wallet and from the provider server via the intermediate server, an indication that the physical credential is verified by the provider server, and provision, by the digital wallet, the digital credential on a secure element of the electronic device.

### CROSS-REFERENCE TO RELATED APPLICATIONS

The present application claims the benefit of U.S. Provisional Patent Application Ser. No. 63/657,730, entitled “PROXIMITY-BASED CREDENTIAL VALIDATION,” filed Jun. 7, 2024, which is hereby incorporated herein by reference in its entirety.

### TECHNICAL FIELD

The present description generally relates to digital credentials on electronic devices and, more particularly, to the validation of digital credentials on electronic devices based on the tapping of a physical credential to an electronic device or otherwise bringing a physical credential in close proximity to an electronic device.

### BACKGROUND

A digital credential is an electronic version of a physical credential, often used for identification, access, or payment purposes. The digital credential may be stored on a digital wallet of a smartphone, computer, or other electronic device and used in place of physical credentials, such as ID cards, credit cards, or membership cards. The type of information and/or access provided by a digital credential may include simple identification and authentication to more complex entitlements and payments, such as credit card payments or other services. Information corresponding to a digital credential may be represented by an identifier, such as a token, device number, and/or the like, which may be presented for use, for example, as an image, sound, code, signal, and/or the like.

### BRIEF DESCRIPTION OF THE DRAWINGS

Certain features of the subject technology are set forth in the appended claims. However, for the purpose of explanation, several implementations of the subject technology are set forth in the following figures.

FIG. 1 illustrates an example network environment for validating a digital credential, in accordance with one or more implementations.

FIG. 2 depicts an example electronic device that may implement the subject methods and systems, in accordance with one or more implementations.

FIG. 3 depicts an example secure element, in accordance with one or more implementations.

FIG. 4 depicts an example tapping process, in accordance with one or more implementations.

FIG. 5 depicts an example validation and/or provisioning process, in accordance with one or more implementations.

FIG. 6 depicts a sequence diagram of an example process for tapping to provision a credential, in accordance with one or more implementations.

FIG. 7 depicts a flow diagram of an example process for tapping to provision a credential, in accordance with one or more implementations.

FIG. 8 depicts a sequence diagram of an example process for tapping to verify a credential, in accordance with one or more implementations.

FIG. 9 depicts a flow diagram of an example process for tapping to verify a credential, in accordance with one or more implementations.

FIG. 10 depicts an example electronic system with which aspects of the present disclosure may be implemented, in accordance with one or more implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

A digital credential is a form of electronic verification used to authenticate and verify the identity of the holder through digital means, enabling secure access to services, resources, or information. A digital credential encompasses a wide array of digital entities, including but not limited to digital payment cards, which can be integrated into digital wallets of devices such as smartphones for NFC-based payments. Digital credentials may be encoded with information that identifies and confirms the legitimacy of the holder, utilizing cryptographic methods for data integrity and security. Unlike physical credentials, digital credentials offer a more convenient and efficient means of carrying and presenting proof of identity, eligibility, or authority, facilitating seamless transactions and interactions in various domains, from financial transactions to secure access to online services.

While digital credentials are a safe method of performing contactless transactions (e.g., payments), one concern is the potential for unauthorized provisioning. For instance, when a credit card is handed over to another person, such as a waiter when paying for a meal, there is a risk that the individual could copy the card details and attempt to provision a digital credential onto their own device fraudulently.

Aspects of the subject technology provide mechanisms for allowing users to seamlessly and securely receive new digital credentials on their electronic device by tapping their contactless physical credentials to their electronic device. With the tap experience, a user's electronic device can utilize its payment terminal capabilities (e.g., NFC reader), for example, to validate the authenticity of the card data and/or submit it to the payment network and/or issuer for validation and/or generation of a digital payment credential. The tap experience is not only more convenient than manually entering information but is also more secure because the physical credential may also include dynamic information, such as a cryptogram. In some instances, the user may also be prompted for a PIN entry following the tap exchange to add a second factor of authentication to the digital credential provisioning attempt. The PIN entry may be cryptographically bound to the card tap so that it cannot be re-used in any other device or provisioning attempt.

Aspects of the subject technology also provide mechanisms for allowing users to prove possession of a contactless physical credential by tapping their contactless physical credential to their electronic device. Tapping to verify the credential provides an added layer of security that may be used alone or in conjunction with, for example, a camera capture of the physical credential's information (e.g., credit card number, name, and/or card verification value (CVV)), manual entry of the physical credential's information, in-app provisioning, and/or the like.

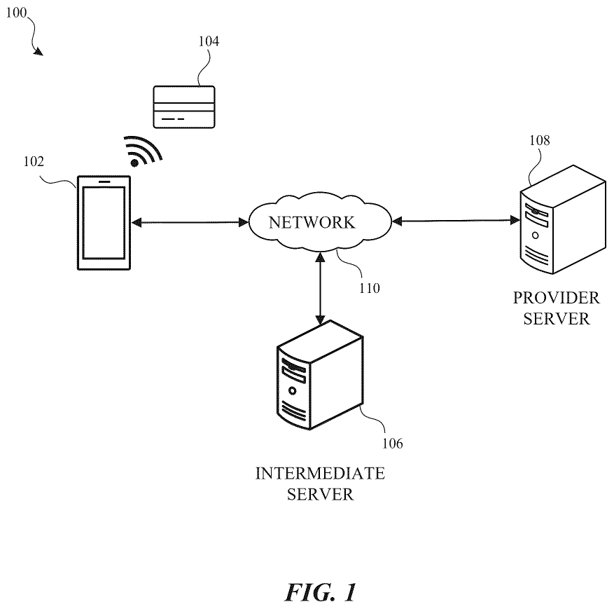

FIG. 1 illustrates an example network environment 100 for validating a digital credential, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102 and one or more servers (e.g., provider server 108 and intermediate server 106). The network 110 may communicatively (directly or indirectly) couple the electronic device 102, the provider server 108, and/or the intermediate server 106. In one or more implementations, the network 110 may be an interconnected network of devices that may include, or may be communicatively coupled to, the Internet. For explanatory purposes, the network environment 100 is illustrated in FIG. 1 as including the electronic device 102, intermediate server 106, the provider server 108, and the intermediate server 106; however, the network environment 100 may include any number of electronic devices and/or any number of servers communicatively coupled to each other directly or via the network 110.

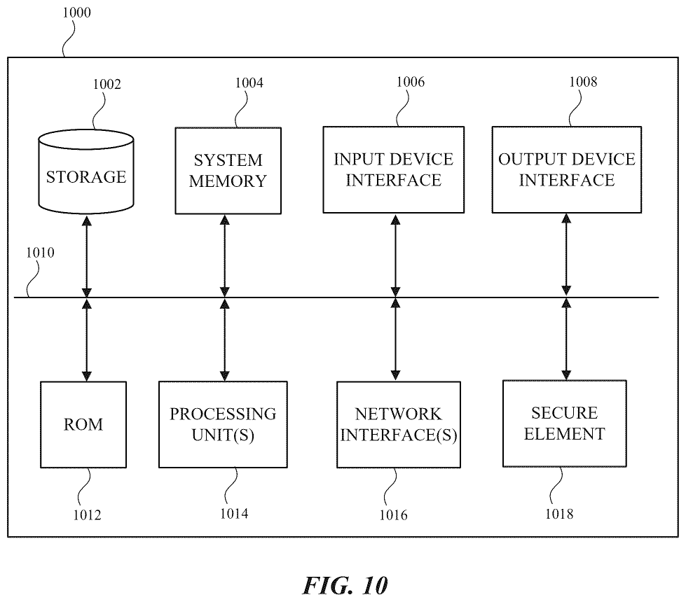

The electronic device 102 may be, for example, a wearable device such as a watch, a band, and the like, a desktop computer, a portable computing device such as a laptop computer, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near-field communication (NFC) radios, and/or other wireless radios. In FIG. 1, by way of example, the electronic device 102 is depicted as a smartphone. The electronic device 102 may be, and/or may include all or part of, the electronic system discussed below with respect to FIG. 10. The electronic device 102 may include one or more digital wallet applications and one or more digital credentials. The electronic device 102 may also be associated with a user account. For example, the electronic device 102 may be registered to a user account at the intermediate server 106. The electronic device 102 may also include an NFC reader and/or transmitter, enabling the electronic device 102 to interact with other NFC-enabled devices or objects within a close range, such as a few centimeters. When activated, the NFC reader may generate an electromagnetic field that powers an NFC tag, allowing for the transfer of data such as payment information, digital identification cards, or smart home commands. Digital payments utilizing the NFC reader and/or transmitting may be secured through encryption and tokenization, so that sensitive information is protected during transactions.

The provider server 108 may facilitate interactions between the electronic device 102 and various online services or resources. Operating within a networked environment (e.g., network 110), the provider server 108 may be owned and/or operated by a payment network, payment credential issuer, and/or other financial institution. The provider server 108 may include one or more applications, applets, or other software processes for receiving and verifying payment credentials (e.g., associated with a credit card). Upon completion, the provider server 108 may generate a response that may include an indication about the validity of the payment credential. For example, when a user taps a contactless payment card 104 against the electronic device 102, the provider server 108 may receive the transmitted tap data, which may include encrypted information unique to the payment card 104 (e.g., a dynamic cryptogram). The tap data may undergo a validation process at the provider server 108 to determine, e.g., the legitimacy of the payment card 104 and the user's identity. Once verified, the provider server 108 may activate the payment card 104 for use. The provider server 108 may also include one or more applications, applets, or other software processes for provisioning digital payment credentials, such as a device primary account number (DPAN) associated with the payment card 104. The digital payment credential may be securely generated and linked to an account of the user so that the digital representation (e.g., DPAN) of the payment card 104 can be used for interactions such as contactless payments. The provider server 108 may then provision the digital payment credential onto the electronic device 102, where it is stored in a secure element or other trusted execution environment.

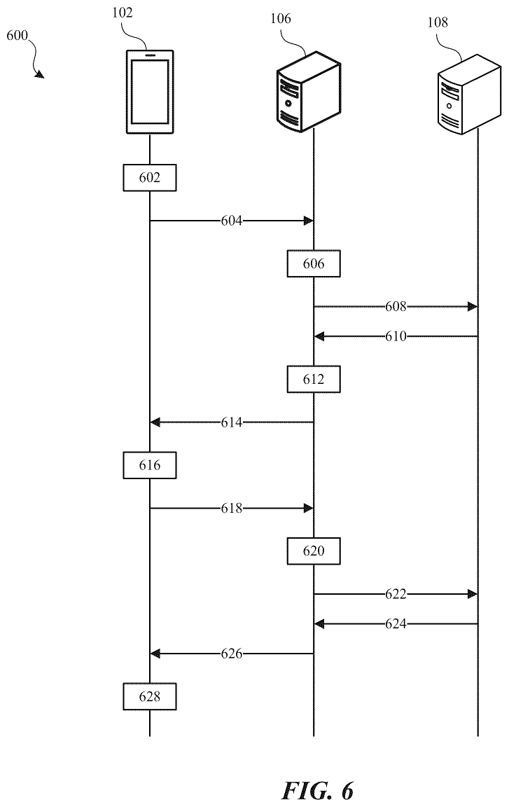

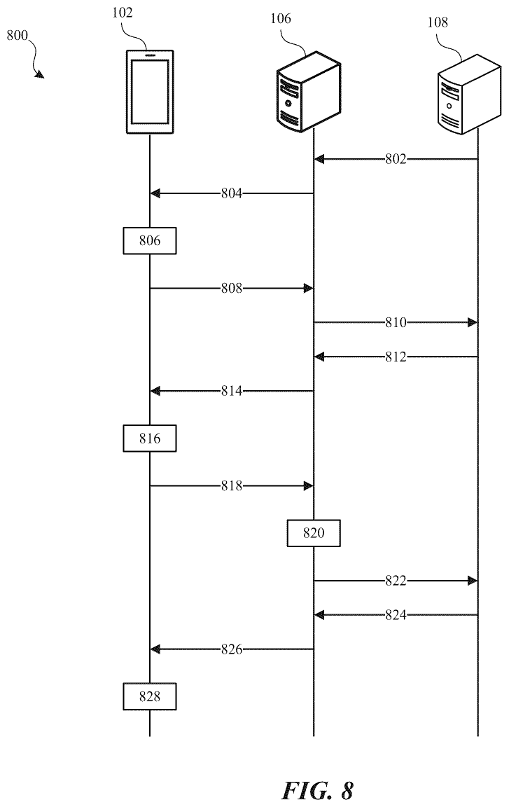

The intermediate server 106 may facilitate interoperability and/or communication between electronic device 102 and provider server 108 as an intermediary. The intermediate server 106 may receive requests or data from an electronic device, then process, convert, repackage, translate, or forward these requests to the other device. Additionally, the intermediate server 106 can provide services such as data encryption and decryption to maintain the security and privacy of the transmitted information and/or perform authentication and authorization functions, verifying the identities of devices and users to prevent unauthorized access. In some implementations, the intermediate server 106 does not facilitate interoperability and the electronic device 102 and provider server 108 may communicate directly for the provisioning and/or verification described below with respect to FIGS. 6 and 8, respectively.

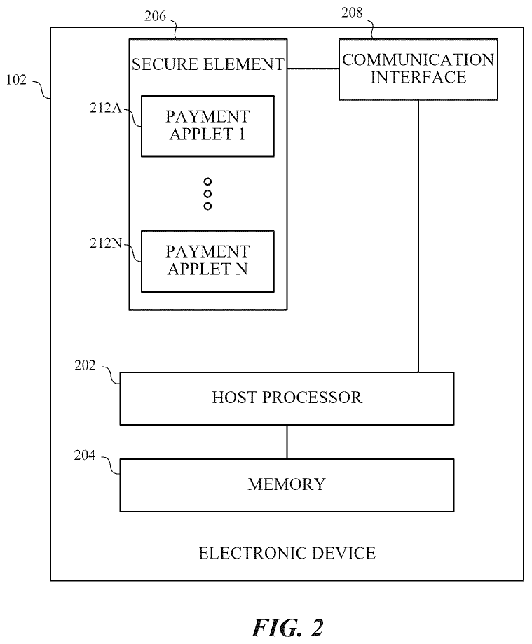

FIG. 2 depicts an example electronic device 102 that may implement the subject methods and systems, in accordance with one or more implementations. For explanatory purposes, FIG. 2 is primarily described herein with reference to the electronic device 102 of FIG. 1. However, this is merely illustrative, and features of the electronic device of FIG. 2 may be implemented in any other electronic device for implementing the subject technology. Not all of the depicted components may be used in all implementations, however, and one or more implementations may include additional or different components than those shown in FIG. 2. Variations in the arrangement and type of the components may be made without departing from the spirit or scope of the claims as set forth herein. Additional components, different components, or fewer components may be provided.

The electronic device 102 may include one or more of a host processor 202, a memory 204, a secure element 206, and/or a communication interface 208. The host processor 202 may include suitable logic, circuitry, and/or code that enable processing data and/or controlling operations of the electronic device 102. In this regard, the host processor 202 may be enabled to provide control signals to various other components of the electronic device 102. The host processor 202 may also control transfers of data between various portions of the electronic device 102. The host processor 202 may further implement an operating system or may otherwise execute code to manage operations of the electronic device 102.

The memory 204 may include suitable logic, circuitry, and/or code that enables storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In one or more implementations, the memory 204 may store applications and application data (e.g., digital credentials).

The communication interface 208 may include suitable logic, circuitry, and/or code that enables wired or wireless communication, such as between the electronic device 102 and the provider server 108. The communication interface 208 may include, for example, one or more of a Bluetooth communication interface, an NFC interface, a Zigbee communication interface, a WLAN communication interface, a universal serial bus (USB) communication interface, a cellular interface, or generally any communication interface. In some implementations, the communication interface 208 may include an NFC controller including one or more antennas and one or more transceivers for transmitting/receiving NFC communications. The NFC controller may further include one or more interfaces, such as a single wire protocol interface, for coupling to the host processor 202 and/or the secure element 206. The NFC controller may be able to communicate via one or more different NFC communication protocols, such as NFC-A (or Type A), NFC-B (or Type B), and/or NFC-F (or Type F or FeliCA). The NFC-A protocol may be based on International Organization for Standardization (ISO)/International Electrotechnical Commission (IEC) 14443A and may use Miller bit coding with a 100 percent amplitude modulation. The NFC-B protocol may be based on ISO/IEC 14443B and may use variations of Manchester encoding along with a 10 percent modulation. The NFC-F protocol may be based on FeliCA JIS X6319-4 and may use a slightly different variation of Manchester coding than the NFC-B protocol. Power may be supplied to the NFC controller and the secure element 206 from a current induced by a wireless reader, such as an NFC reader of a payment terminal. Thus, in one or more implementations, the NFC controller and the secure element 206 may be able to present digital credentials even when the electronic device 102 is unable to supply power to the NFC controller and/or the secure element 206.

The secure element 206 may include hardware that provides secure storage and management of sensitive information. The secure element 206 may be securely isolated from the host processor 202 and operating system, making it more difficult for unauthorized access. The secure element 206 may be used for secure transactions and/or identification, such as payment credentials, digital passes, and the like. The secure element 206 may store sensitive information, such as cryptographic keys or digital credentials, and may protect the sensitive information with cryptographic algorithms and access controls. For example, the secure element 206 may include a hardware specific private key that is provisioned on the secure element 206 at or near the time of manufacture. The use of the secure element 206 provides an additional layer of security for sensitive information and helps to ensure its confidentiality in case the electronic device 102 is lost or compromised.

The secure element 206 may include one or more interfaces for communicatively coupling (directly or indirectly) to the communication interface 208 (e.g., NFC controller) and/or the host processor 202, such as via one or more single wire protocol (SWP) connections and/or any other data connection. The secure element 206 may include one or more payment applets 212A-N, which may be referred to herein as applets 212A-N. In one or more implementations, the operating system and/or execution environment of the secure element 206 may be a JAVA-based operating system and/or JAVA-based execution environment, and the applets 212A-N may be JAVA-based applets. In other implementations, other operating systems, languages, and/or environments can be implemented. In addition to the one or more applets 212A-N, the secure element 206 may also include one or more additional applets for performing other operations, such as a security applet, a registry applet, and the like. A payment applet that is provisioned on the secure element 206 may correspond to a digital payment credential (e.g., generated by the provider server 108).

The applets 212A-N and/or corresponding digital credentials may be provisioned on the secure element 206 at least in part by, for example, a trusted services manager (TSM) server, intermediate server 106, and/or provider server 108. In some implementations, the intermediate server 106 and/or the provider server 108 may be a TMS. The TSM may transmit a provisioning script to the electronic device 102 via the network 110. In some implementations, the host processor 202 of the electronic device 102 may receive the script and may provide the script to the secure element 206, such as via the communication interface 208 and/or directly to the secure element 206. The secure element 206 may perform one or more security mechanisms to verify the received script, such as one or more security mechanisms inherent in the GlobalPlatform framework and may then execute the received script.

The execution of the script by the secure element 206 may cause one or more of the applets 212A-N and/or corresponding digital credentials to be provisioned on the secure element 206. Each of the applets 212A-N may be provisioned with one or more of an applet identifier, a digital credential, an identifier of the associated service provider, and/or one or more attributes. The applet identifier associated with a given payment applet 212A may be used by, for example, the host processor 202 and/or a trusted services manager server to uniquely identify the payment applet 212A relative to the other applets 212B-N provisioned on the secure element 206, such as to perform one or more operations with respect to the payment applet 212A. In one or more implementations, the applet identifiers may be used by the host processor 202 to store associations between the applets 212A-N and their corresponding service providers.

The digital credential may be associated with an account, such as a credit card account, associated with a given payment applet 212A. When conducting a wireless payment transaction using one of the payment applets 212A-N, the secure element 206 may provide the digital credential to a terminal. The terminal may then forward the digital credential to the associated service provider who can determine the account associated with the digital credential and confirm that the account contains sufficient funds and/or credit to complete the wireless payment transaction.

In one or more implementations, the applets 212A-N may be provisioned with an attribute that indicates the type of communication protocol used by the applets 212A-N to communicate with a wireless payment terminal. The types of communication protocols may include, for example, an NFC-A protocol, an NFC-B protocol, an NFC-F protocol, a Bluetooth protocol, a Bluetooth low energy (BLE) protocol, a Zigbee protocol, a Wi-Fi protocol, or generally any communication protocol.

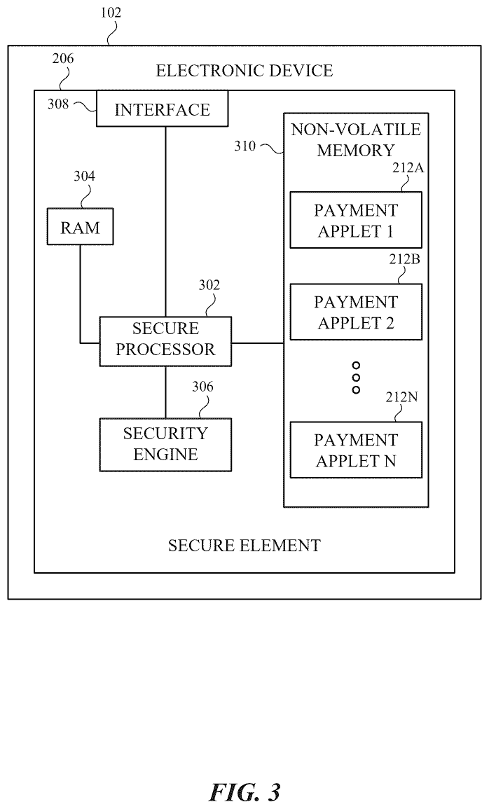

In some implementations, one or more of the payment applets 212A-N may be associated with the same service provider, such as the same financial institution, and/or may be associated with different service providers. In one or more implementations, such as a host card emulation implementation, all or part of the secure element 206 may be implemented by the host processor 202, and therefore, in one or more implementations, the secure element 206 may not be included in the electronic device 102. The secure element 206 and the applets 212A-N provisioned thereon are discussed further below with respect to FIG. 3.

In one or more implementations, one or more of the host processor 202, the memory 204, the secure element 206, the communication interface 208, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 depicts the secure element 206, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided. For explanatory purposes, the secure element 206 is illustrated as being implemented in the electronic device 102; however, the secure element 206 may be implemented in any other electronic device.

The secure element 206 may include, among other components, a secure processor 302, RAM 304, a security engine 306, an interface 308, and non-volatile memory 310. The RAM 304 may include one or more of static RAM (SRAM) and/or dynamic RAM (DRAM). The interface 308 may communicatively couple the secure element 206 to one or more other chips in the device, such as the communication interface 208 (e.g., NFC controller) and/or the host processor 202. The interface 308 may be, for example, a SWP interface, a USB interface, or generally any data interface. The secure processor 302 may be, for example, a reduced instruction set computing (RISC) processor, an advanced RISC machine (ARM) processor, or generally any processing circuitry.

The security engine 306 may perform one or more security operations for the secure element 206. For example, the security engine 306 may perform cryptographic operations and/or may manage cryptographic keys and/or certificates. In one or more implementations, the communications between the secure element 206 and an external device, such as a wireless payment terminal and/or trusted services manager server may be encrypted. For example, for NFC-F communications, an encryption key may be dynamically generated each time mutual authentication is performed. In these one or more implementations, the encryption/decryption and/or key generation/management may be performed all or in part by the security engine 306.

The non-volatile memory 310 may be and/or may include, for example, flash memory. The non-volatile memory 310 may store the attributes and executable code associated with the applets 212A-N. In one or more implementations, the non-volatile memory 310 may also store firmware and/or operating system executable code that is executed by the secure processor 302 to provide the execution environment for the applets 210A-N, 212A-N, such as a JAVA execution environment.

In one or more implementations, one or more of the secure processor 302, the RAM 304, the security engine 306, the interface 308, the non-volatile memory 310, and/or one or more portions thereof, may be implemented in software (e.g., subroutines and code), hardware (e.g., an ASIC, an FPGA, a PLD, a controller, a state machine, gated logic, discrete hardware components, or any other suitable devices) and/or a combination of both.

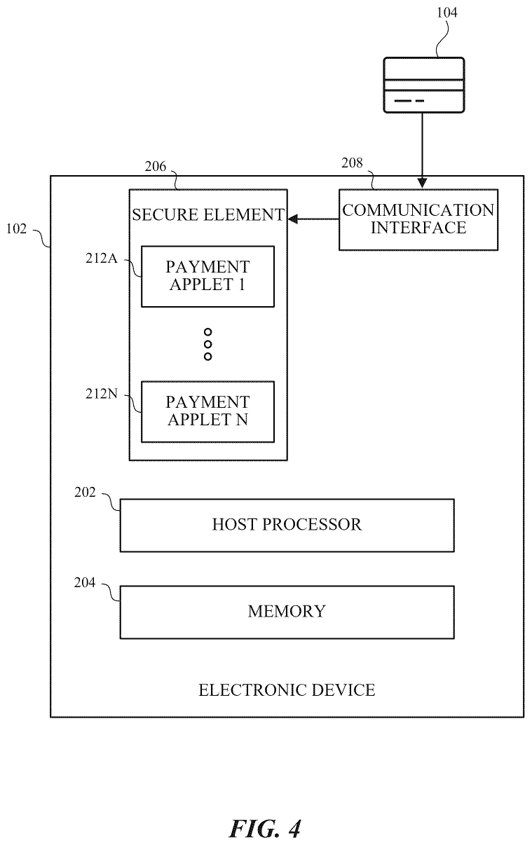

FIG. 4 depicts an example tapping process, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

A validation and/or provisioning session may be initiated at the electronic device 102. For example, a digital wallet may be launched on the electronic device 102, and the user may select an option in the digital wallet to verify and/or add a credential. After initiating the session, the user may tap a contactless payment card 104 to the electronic device 102. The tapping process for contactless credentials, such as credit cards, may involve a user bringing the contactless credential in close proximity to the electronic device 102. After initiating the session, the electronic device 102 may activate an NFC reader (e.g., communication interface 208) to generate a radio frequency field that may activate an NFC tag embedded within the payment card 104. For example, the NFC reader may generate a radio frequency via inductive coupling in which the NFC reader passes an electric current through its coil to create a magnetic field. When an NFC tag, such as a chip of a contactless credit card, enters the magnetic field, electricity may be induced in the NFC tag's coil, allowing the NFC tag to transmit data back to the NFC reader using modulated radio waves. The chip may then transmit its encrypted data, such as the card number, expiration date, and/or cryptogram, back to the NFC reader through modulated radio waves.

In some implementations, the NFC reader may continuously emit signals at a predefined frequency (e.g., a polling rate) to detect the presence of NFC tags. When an NFC tag is detected, the NFC reader and the NFC tag may engage in a communication process that involves a series of handshakes to establish a secure connection. In some implementations, the NFC reader may include a timeout period in which the NFC reader waits for a response from the NFC tag before the NFC reader stops trying to establish a connection. For instance, an NFC reader may have a timeout period set to 20 seconds, after which it will cease communication attempts if no response is received.

Once the NFC reader receives the tap data from the NFC tag of the payment card 104, the NFC reader may provide the tap data to the secure element 206. The tap data may be provided directly to the secure element 206, bypassing any application process, as a security measure to prevent any application processes from intercepting the tap data. The secure element 206 may store the tap data for the duration of the validation and/or provisioning session. In some implementations, the secure element 206 may store the tap data in association with a payment applet 212A-N. Depending on the tap data, a corresponding payment applet 212A may be activated to facilitate the remainder of the validation and/or provisioning session.

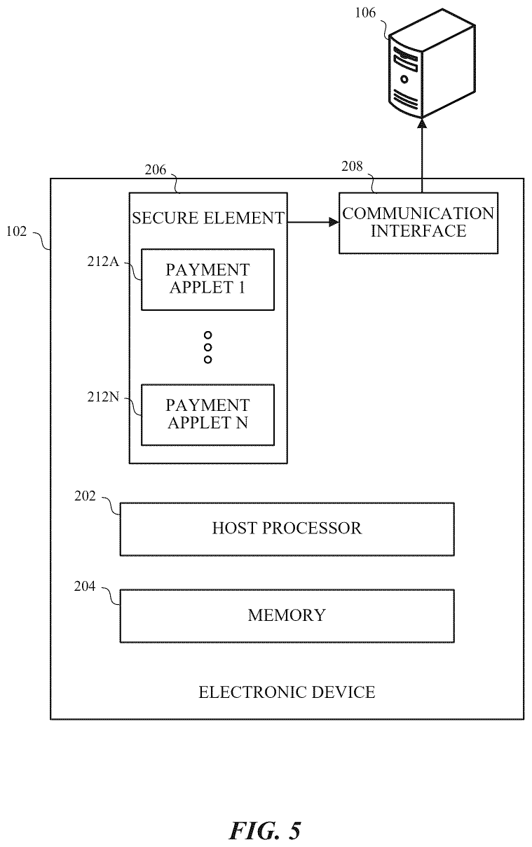

FIG. 5 depicts an example validation and/or provisioning process, in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

Following the initial capture and secure storage of tap data within the smartphone's secure element (e.g., as described with respect to FIG. 4), the subsequent stages of data handling may involve a series of cryptographic operations and communications with external servers to facilitate the validation of the payment card 104 and/or provisioning of a digital credential. The secure element 206, having temporarily stored and/or associated the tap data with the relevant payment applet 212A, may initiate the next step by encrypting the tap data. The tap data may then be provided to the communication interface 208, such as a network interface card (NIC) or modem, which may be responsible for establishing a connection to external networks (e.g., network 110) and transmitting data (e.g., to intermediate server 106).

In some implementations, the communication interface 208 may establish a connection with the intermediate server 106. The intermediate server 106 may facilitate the verification and/or provisioning of digital credentials (e.g., via the process 600 described below with respect to FIG. 6) by converting, translating, or otherwise processing data from the communication interface 208 to be compatible with the provider server 108, and/or data from the provider server 108 to be compatible with the communication interface 208.

In some implementations, the communication interface 208 may also or instead establish a connection directly with the provider server 108. The communication interface 208 (or any other component of the electronic device 102) may convert, translate, or otherwise process data from components of the electronic device 102 to be compatible with the provider server 108 and/or data from the provider server 108 to be compatible with the components of the electronic device 102. Additionally or alternatively, the components of the electronic device 102 that communicate with the provider server 108 may generate and/or provide data compatible with the provider server 108.

FIG. 6 depicts a sequence diagram of a process 600 for tapping to provision a credential, in accordance with one or more implementations. For explanatory purposes, the process 600 is primarily described herein with reference to the electronic device 102, the intermediate server 106, and the provider server 108 of FIGS. 1-5. However, the process 600 is not limited to the electronic device 102, the intermediate server 106, or the provider server 108. Further, for explanatory purposes, the periods of the process 600 are described herein as occurring sequentially or linearly. However, multiple periods of the process 600 may occur in parallel. In addition, the periods of the process 600 need not be performed in the order shown and/or one or more periods of the process 600 need not be performed and/or can be replaced by other operations.

At period 602, to start the digital credential provisioning process, a user may launch a digital wallet application on their electronic device 102. The digital wallet may be a software application designed to manage payment credentials and/or facilitate financial transactions and may serve as the interface through which the user interacts with a broader payment ecosystem. Upon launching the digital wallet application, the user may be presented with various options, including adding or provisioning a new payment credential, allowing users to obtain a digital version of their physical payment cards for use in contactless transactions. A user interface element of the digital wallet application may prompt the user to bring their physical credential, payment card 104, into close proximity (e.g., NFC proximity) with the electronic device 102 (also referred to herein as tapping the physical credential on the electronic device 102). This instruction prepares the user to engage in an NFC interaction and indicates that the NFC controller (e.g., communication interface 208) is being activated so that the payment card 104 and the electronic device 102 can exchange secure payment information wirelessly.

As the user taps (e.g., brings within NFC communication range) their physical credential against their device, the NFC controller may capture data from the payment card 104 (referred to herein as “tap data”). Tap data may include data for identifying the payment card 104 and its issuer (e.g., provider server 108) within the payment network, such as the financial payment account number (FPAN), cardholder's name, country code, credential cryptogram (e.g., dynamically generated by the payment card 104), security code (e.g., CVV), and/or other information from the payment card 104. Once the tap data is captured, the NFC controller may provide the tap data directly to the secure element 206. Upon receiving the tap data, the secure element 206 may encrypt the tap data.

At period 604, the electronic device 102 may transmit at least some of the tap data to the intermediate server 106. The intermediate server 106 may act as a bridge within the broader payment ecosystem, facilitating further processing of the tap data. The transmission of the tap data may be conducted over secure communication channels to maintain the integrity and confidentiality of the tap data during transit. In some embodiments, the intermediate server 106 may not be utilized, and the electronic device 102 and the provider server 108 may communicate directly.

At period 606, upon receiving the tap data from the electronic device 102, the intermediate server 106 may relay the tap data to the provider server 108.

In some embodiments, the intermediate server 106 may also verify the digital credential provisioning request. The verification process may include checking that the user is authorized to receive a digital credential, which may involve authenticating the user's identity and confirming eligibility based on predefined criteria set by, for example, the payment network or financial institution. The verification process may also include checks against the user's account status, prior transaction history, and/or compliance with anti-fraud measures.

In addition to or instead of the authorization check, the intermediate server 106 may proceed to verify the provisioning session itself. The verification may be designed to verify that the request to provision a digital credential originates from a legitimate, secure session initiated by the electronic device 102. Verification of the provisioning session can include analyzing session tokens, timestamps, and/or other security parameters that link the session to the electronic device 102 and/or digital wallet application. This measure may prevent unauthorized provisioning attempts and verify that the digital credential is being issued to the correct device and user.

Additionally or alternatively, the intermediate server 106 may repackage the tap data for transmission to the provider server 108. Repackaging may involve decrypting the tap data, converting the tap data into a format or protocol that is recognized and accepted by the provider server 108, inserting metadata required for processing by the provider server 108, and/or re-encrypting the tap data for transmission to the provider server 108.

At period 608, the tap data may be sent to the provider server 108 by the intermediate server 106.

At period 610, upon receiving the tap data, the provider server 108 may determine the eligibility of the account associated with the physical credential for tapping to provision a payment credential. If the account is not eligible, the provider server 108 may generate a response to the intermediate server 106 indicating that the account is not eligible and/or that the provisioning request should be entered by a different method (e.g., manual entry of the payment card information). If the account is eligible, the provider server 108 may determine whether other requirements must be satisfied before provisioning the digital credential. For example, the provider server 108 may require that the user provides a PIN to associate with the digital credential or may require that the user agree to certain terms and conditions. If there are other requirements to be satisfied before provisioning the digital credential, the provider server 108 may generate a response to the intermediate server 106 indicating the other requirements. Otherwise, if the user's account is eligible for tap to provision and there are no further requirements, the provider server 108 may proceed to period 624, where the credential is provisioned.

At period 612, the intermediate server 106 may receive the response from the provider server 108. In some implementations, the intermediate server 106 may be associated with an account of the user and thus may include information that can be provided to the provider server 108 to satisfy the additional requirements included in the response.

At period 614, the intermediate server 106 may provide the response from the provider server 108 and/or other related material to the electronic device 102. For example, if the response indicates that the user must approve of the provider's terms and conditions, the terms and conditions may be provided to the electronic device 102 for the user to review and approve. The response may also indicate, for example, whether a PIN is required, whether a CVV is required, whether the physical credential is eligible for tap to provision, and/or the like.

At period 616, the electronic device 102 may obtain and/or generate any necessary information to satisfy the requirements as indicated in the response from the intermediate server 106 and/or the provider server 108. In some implementations, if tap to provision is supported but a PIN is required, the electronic device 102 may request and capture a PIN input by the user (e.g., via a user interface of the digital wallet application). The PIN and/or any other physical credential information such as the FPAN, session identifier, and/or the like, may be used to generate a PIN block. The PIN block may be in a format defined according to ISO 9564, such as format 4. In some implementations, if tap to provision is not supported, the electronic device 102 may capture and request physical credential information, such as the CVV and card holder name.

At period 618, the electronic device 102 may encrypt and send any captured data (e.g., PIN, payment card information, and/or the like) to the intermediate server 106.

At period 620, the intermediate server 106 may initiate a verification process as described with respect to period 606, which may include repackaging the PIN block and/or the physical credential information.

At period 622, the tap data (e.g., when there are no additional requirements from the provider server 108), the PIN block (e.g., when there are additional requirements from the provider server 108), and/or the physical credential information (e.g., when tap to provision is not supported for the user), may be sent to the provider server 108. The provider server 108 may represent the financial institution or payment network responsible for ultimately issuing the digital credential.

At period 624, the provider server 108 may verify the tap data and generate a digital payment credential (such as a DPAN) representing the credential. The provider server 108 may provide the digital payment credential to the intermediate server 106.

At period 626, the intermediate server 106 may transmit a provisioning script to the electronic device 102 (e.g., via the network 110). The provisioning script may include (or cause the secure element 206 to obtain) the digital payment credential, associated payment applet (e.g., 212A), and/or one or more instructions for storing the digital payment credential and/or associated payment applet in the secure element 206.

At period 628, the electronic device 102 (e.g., an application process associated with the digital wallet application) may receive the script and may provide the script to the secure element 206, such as via the communication interface 208 (e.g., an NFC controller and/or directly to the secure element 206). The secure element 206 may perform one or more security mechanisms to verify the provisioning script and may execute the provisioning script. The execution of the provisioning script by the secure element 206 may cause the digital payment credential and/or one or more of the applets 212A-N to be provisioned on the secure element 206.

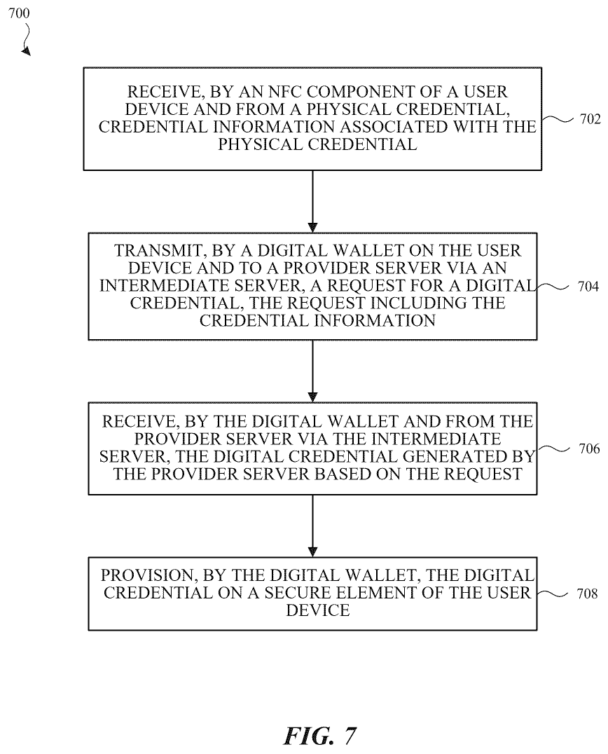

FIG. 7 depicts a flow diagram of an example process 700 for tapping to provision a credential, in accordance with one or more implementations. For explanatory purposes, the process 700 is primarily described herein with reference to the electronic device 102, the intermediate server 106, and the provider server 108 of FIGS. 1-5. However, the process 700 is not limited to the electronic device 102, the intermediate server 106, or the provider server 108. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, an NFC component (e.g., communication interface 208) of the electronic device 102 may receive credential information from a physical credential (e.g., payment card 104). The electronic device 102 may receive the credential information by tapping, touching, scanning, or otherwise interacting with the physical credential. The credential information may include a card number (e.g., FPAN), expiry date, credential cryptogram (e.g., dynamically generated by the contactless physical credential), security code (e.g., CVV), and/or other information from the physical credential.

In some embodiments, a digital wallet application may first be launched and may remain launched for the duration of the process 700.

In some embodiments, the credential information may be received by the NFC component and provided directly to the secure element 206, bypassing the host processor 202 of the electronic device 102, and may be stored on the secure element 206 (e.g., non-volatile memory 310).

At block 704, a digital wallet application running on the electronic device 102 may transmit (e.g., via a communication interface 208) a request for a digital credential to the intermediate server 106. The request may include the credential information from block 702. The intermediate server 106 may process and/or relay the request to the provider server 108. The provider server 108 may verify the request and, if the request is approved, generate a digital credential to be provisioned on the electronic device 102.

In some embodiments, the provider server 108 may require additional information upon verifying the request (e.g., periods 610, 614). For example, if the provider server 108 requires a password (e.g., a PIN), the user may enter a password on an input interface (e.g., input device interface 1006) of the digital wallet, which may be provided to the secure element 206. Similarly, if the provider server 108 requires a security code (e.g., CVV) from the payment card 104, the user may manually input the security code and/or the security code may be extracted from the tap data. The secure element 206 may generate a cryptogram (e.g., a PIN block) based on the password, security code, and/or other information input by the user. The cryptogram may be provided to the provider server 108 via the same or different request for a digital credential.

At block 706, the digital wallet application may receive a provisioning script for providing to the secure element 206. The provisioning script may be received from the intermediate server 106, which may receive the digital credential from the provider server 108. The provisioning script may include the digital credential, a corresponding payment applet, and/or one or more instructions for storing the digital payment credential and/or corresponding payment applet in the secure element 206. In some embodiments, the provisioning script may be provided directly to the secure element 206 by the intermediate server 106 and/or provider server 108.

At block 708, the digital credential may be provisioned onto the secure element 206 of the electronic device 102. To provision the digital credential, the secure element 206 may receive the provisioning script, which may include the digital credential or cause the secure element 206 to obtain the digital credential. The provisioning script may be received from the digital wallet application and/or the intermediate server 106. The provisioning script may include instructions that, when executed by the secure element 206, may cause the secure element 206 to store the digital credential (and/or corresponding applet) onto the non-volatile memory 310 of the secure element 206.

After the digital credential is provisioned, the digital wallet application may render a representation of the digital credential on a user interface of the digital wallet application. For example, the digital wallet application may render an image resembling the physical credential associated with the digital credential.

FIG. 8 depicts a sequence diagram of an example process 800 for tapping to verify a credential, in accordance with one or more implementations. For explanatory purposes, the process 800 is primarily described herein with reference to the electronic device 102, the intermediate server 106, and the provider server 108 of FIGS. 1-5. However, the process 800 is not limited to the electronic device 102, the intermediate server 106, or the provider server 108. Further, for explanatory purposes, the periods of the process 800 are described herein as occurring sequentially or linearly. However, multiple periods of the process 800 may occur in parallel. In addition, the periods of the process 800 need not be performed in the order shown and/or one or more periods of the process 800 need not be performed and/or can be replaced by other operations.

At period 802, the provider server 108 may request for the user to provide proof of possession of a physical credential. The provider server 108 may request proof of possession, for example, before generating a digital credential for the user, to activate the physical credential, to activate a digital credential, and/or the like. In some embodiments, the request for proof of possession may follow or be accompanied by a digital credential from the provider server 108.

At period 804, the intermediate server 106 may relay the request to the electronic device 102. For example, the intermediate server 106 may generate a push notification relating to the request and cause the push notification to be displayed on the electronic device 102. In some embodiments, the intermediate server 106 may not be utilized, and the electronic device 102 and the provider server 108 may communicate directly.

At period 806, the user may launch a digital wallet application on their electronic device 102. The digital wallet may be a software application designed to manage payment credentials and/or facilitate financial transactions and may serve as the interface through which the user interacts with a broader payment ecosystem.

Upon launching the digital wallet application and/or receiving the request, the user may be presented with various options, including verifying a digital credential with a corresponding physical credential. Rather than calling a particular phone number or visiting a particular website on a web browser, the digital wallet application, utilizing the interface elements (e.g., output device interface 1008) of the electronic device 102, may prompt the user to bring their physical credential (e.g., payment card 104) into close proximity (e.g., NFC proximity) with the electronic device 102 (also referred to herein as tapping the physical credential to the electronic device 102). This instruction prepares the user to engage in an NFC interaction and indicates that the NFC controller (e.g., communication interface 208) is being activated so that the physical credential and the electronic device 102 can exchange secure payment information wirelessly.

As the user taps (e.g., brings within NFC communication range) their physical credential against the electronic device 102, the NFC controller may capture data from the physical credential (referred to herein as “tap data”). Tap data may include credential data requested by the provider server 108, such as the cryptogram, the FPAN, the cardholder's name, and/or the country code. Once the tap data is captured, the NFC controller may provide the tap data directly to the secure element 206. Upon receiving the tap data, the secure element 206 may encrypt the tap data. The electronic device 102 may generate a response to the request from the provider server 108, and the response may include at least some of the tap data, session tokens, digital signatures, and/or other data relevant to the request.

In some embodiments, the request from the provider server 108 may require a PIN. The electronic device 102 may request and capture (e.g., via a user interface of the digital wallet application) a PIN input by the user. The PIN and any other payment card information such as the cryptogram, FPAN, session identifier, and/or the like, may be used to generate a PIN block. The PIN block may be in a format defined according to ISO 9564, such as format 4. In addition to or instead of the tap data, the response may include the PIN and/or the PIN block.

At period 808, the electronic device 102 may transmit a response to the intermediate server 106. The intermediate server 106 may act as a bridge within the broader payment ecosystem, facilitating further processing of the tap data. The transmission of the response may be conducted over secure communication channels to maintain the integrity and confidentiality of the tap data during transmission.

At period 810, upon receiving the response from the electronic device 102, the intermediate server 106 may relay the response to the provider server 108.

In some embodiments, the intermediate server 106 may verify the session. The verification may be designed to verify that the response originates from a legitimate, secure session initiated by the electronic device 102. Verification of the session can include analyzing session tokens, timestamps, and/or other security parameters that link the session to the user's specific device and/or digital wallet application. This measure may prevent unauthorized verification attempts and verifies that the digital credential is being issued to the correct device and user.

Additionally or alternatively, the intermediate server 106 may repackage contents of the response for transmission to the provider server 108. Repackaging may involve decrypting the tap data, converting the tap data into a format or protocol that is recognized and accepted by the provider server 108, inserting metadata required for processing by the provider server 108, and/or re-encrypting the tap data for transmission to the provider server 108.

At period 812, upon receiving the response, the provider server 108 may verify the tap data according to predefined rules and criteria. The verification may involve checking the validity of a session token, the authenticity of a digital signature, the compatibility of the credential type and version, compliance with security standards, and/or fulfillment of the issuer's policies. For example, the provider server 108 may compare a session token of the session with a stored record of sessions initiated by the intermediate server 106 and/or the electronic device 102, verify the digital signature using a public key encryption algorithm, check the credential type and version against a list of supported formats, verify that the tap data meets the minimum encryption level or other security requirements, and/or evaluate the tap data against the issuer's rules and conditions for issuing the digital credential. If any of the verification steps fail, the provider server 108 may reject the response and send an error message to the intermediate server 106 or the electronic device 102. If the verification steps succeed, possession of the physical credential may be considered proven, and the provider server 108 may send an indication of success to the electronic device 102.

Additionally, in some embodiments, the provider server 108 may proceed to the next periods. For example, in the remaining periods 814-828, the provider server 108 may provision a digital credential in a manner corresponding to periods 614-628, which are described above.

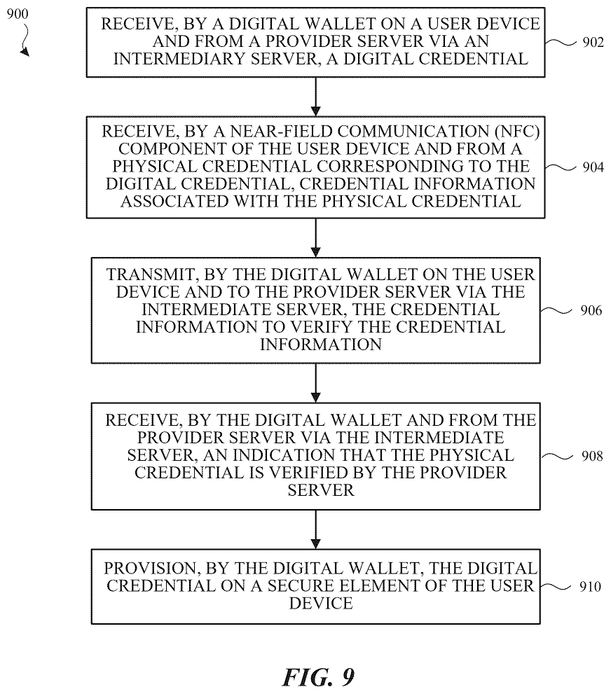

FIG. 9 depicts a flow diagram of an example process 900 for tapping to verify a credential, in accordance with one or more implementations. For explanatory purposes, the process 900 is primarily described herein with reference to the electronic device 102, the intermediate server 106, and the provider server 108 of FIGS. 1-5. However, the process 900 is not limited to the electronic device 102, the intermediate server 106, or the provider server 108. Further, for explanatory purposes, the blocks of the process 900 are described herein as occurring sequentially or linearly. However, multiple blocks of the process 900 may occur in parallel. In addition, the blocks of the process 900 need not be performed in the order shown and/or one or more blocks of the process 900 need not be performed and/or can be replaced by other operations.

At block 902, a digital wallet on the electronic device 102 may receive a digital credential from the provider server 108 via the intermediate server 106. The digital credential may correspond to a physical credential (e.g., payment card 104). In some embodiments, a digital wallet application may first be launched and may remain launched for the duration of the process 900.

At block 904, an NFC component (e.g., communication interface 208) of the electronic device 102 may receive credential information from the physical credential. The electronic device 102 may receive the credential information by tapping, touching, scanning, or otherwise interacting with the physical credential. The credential information may include a card number (e.g., FPAN), expiry date, credential cryptogram, security code (e.g., CVV), and/or other information from the physical credential. The electronic device 102 may generate a response to the provider server 108, and the response may include at least some of the credential information.

In some embodiments, the credential information may be received by the NFC component and provided directly to the secure element 206, bypassing the host processor 202 of the electronic device 102, and may be stored on the secure element 206 (e.g., non-volatile memory 310).

In some embodiments, a graphical user input interface (e.g., via input device interface 1006) of the digital wallet may receive a password (e.g., PIN) input by the user. The secure element 206 may generate a cryptogram (e.g., a PIN block) based on the password, security code, and/or other information input by the user. The response may also or instead include the cryptogram.

At block 906, the digital wallet running on the electronic device 102 may transmit (e.g., via a communication interface 208) the response to the intermediate server 106. The provider server 108 may receive the response from the intermediate server 106 and verify the credential information based on the response.

At block 908, if the verification is successful, the digital wallet may receive an indication that the physical credential is verified by the provider server 108. The indication may include a notification, alert, or any other kind of message provided to the electronic device 102 from the intermediate server 106.

At block 910, once possession of the physical credential is proven, the digital wallet may provision the digital credential onto the secure element 206 of the electronic device 102. After the digital credential is provisioned, the digital wallet may render a representation of the digital credential. For example, the digital wallet may render an image resembling the physical credential associated with the digital credential.

In some embodiments, the digital credential is inactive when it is received, and the digital credential is activated in response to receiving the indication that the physical credential is verified.

FIG. 10 depicts an example electronic system 1000 with which aspects of the present disclosure may be implemented, in accordance with one or more implementations. The electronic system 1000 can be, and/or can be a part of, any electronic device for generating the features and processes described in reference to FIGS. 1-9, including but not limited to a laptop computer, tablet computer, smartphone, and wearable device (e.g., smartwatch, fitness band). The electronic system 1000 may include various types of computer-readable media and interfaces for various other types of computer-readable media. The electronic system 1000 includes one or more processing unit(s) 1014, a persistent storage device 1002, a system memory 1004 (and/or buffer), an input device interface 1006, an output device interface 1008, a bus 1010, a ROM 1012, one or more processing unit(s) 1014, one or more network interface(s) 1016, a secure element 1018, and/or subsets and variations thereof.

The bus 1010 collectively represents all system, peripheral, and chipset buses that communicatively connect the numerous internal devices of the electronic system 1000. In one or more implementations, the bus 1010 communicatively connects the one or more processing unit(s) 1014 with the ROM 1012, the system memory 1004, and the persistent storage device 1002. From these various memory units, the one or more processing unit(s) 1014 retrieves instructions to execute and data to process in order to execute the processes of the subject disclosure. The one or more processing unit(s) 1014 can be a single processor or a multi-core processor in different implementations.

The ROM 1012 stores static data and instructions that are needed by the one or more processing unit(s) 1014 and other modules of the electronic system 1000. The persistent storage device 1002, on the other hand, may be a read-and-write memory device. The persistent storage device 1002 may be a non-volatile memory unit that stores instructions and data even when the electronic system 1000 is off. In one or more implementations, a mass-storage device (such as a magnetic or optical disk and its corresponding disk drive) may be used as the persistent storage device 1002.

In one or more implementations, a removable storage device (such as a floppy disk, flash drive, and its corresponding disk drive) may be used as the persistent storage device 1002. Like the persistent storage device 1002, the system memory 1004 may be a read-and-write memory device. However, unlike the persistent storage device 1002, the system memory 1004 may be a volatile read-and-write memory, such as RAM. The system memory 1004 may store any of the instructions and data that one or more processing unit(s) 1014 may need at runtime. In one or more implementations, the processes of the subject disclosure are stored in the system memory 1004, the persistent storage device 1002, and/or the ROM 1012. From these various memory units, the one or more processing unit(s) 1014 retrieves instructions to execute and data to process in order to execute the processes of one or more implementations.

The bus 1010 also connects to the input device interfaces 1006 and output device interfaces 1008. The input device interface 1006 enables a user to communicate information and select commands to the electronic system 1000. Input devices that may be used with the input device interface 1006 may include, for example, alphanumeric keyboards, touch screens, and pointing devices. The output device interface 1008 may enable the electronic system 1000 to communicate information to users. For example, the output device interface 1008 may provide the display of images generated by electronic system 1000. Output devices that may be used with the output device interface 1008 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information.

One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 1010 also connects to secure element 1018. The secure element 1018 may include hardware and/or software that provides secure storage and management of sensitive information. The secure element 1018 may be isolated from the processing unit 1014 and operating system, making it more difficult for unauthorized access. The secure element 1018 may be used for secure transactions and identification, such as in payment cards and digital passes. The secure element 1018 may store sensitive information, such as cryptographic keys, and may protect the sensitive information (e.g., with cryptographic algorithms and access controls).

Finally, as shown in FIG. 10, the bus 1010 also couples the electronic system 1000 to one or more networks and/or to one or more network nodes through the one or more network interface(s) 1016. In this manner, the electronic system 1000 can be a part of a network of computers (such as a local area network, a wide area network, an Intranet, or a network of networks, such as the Internet). Any or all components of the electronic system 1000 can be used in conjunction with the subject disclosure.

Implementations within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more implementations are performed by one or more integrated circuits, such as ASICs or FPGAs. In one or more implementations, such integrated circuits execute instructions that are stored on the circuit itself.

As described above, one aspect of the present technology is the gathering and use of data available from specific and legitimate sources for file sharing. The present disclosure contemplates that in some instances, this gathered data may include personal information data that uniquely identifies or can be used to identify a specific person. Such personal information data can include demographic data, location-based data, online identifiers, telephone numbers, email addresses, home addresses, images, videos, audio data, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, personal information data can be used for file sharing. Accordingly, the use of such personal information data may facilitate transactions (e.g., online transactions). Further, other uses for personal information data that benefit the user are also contemplated by the present disclosure. For instance, health and fitness data may be used, in accordance with the user's preferences to provide insights into their general wellness or may be used as positive feedback to individuals using technology to pursue wellness goals.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of file sharing, the present technology can be configured to allow users to select to “opt-in” or “opt-out” of participation in the collection of personal information data during registration for services or anytime thereafter. In addition to providing “opt-in” and “opt-out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, one or more implementations, an embodiment, the embodiment, another embodiment, one or more implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any implementation described herein as “exemplary” or as an “example” is not necessarily to be construed as preferred or advantageous over other implementations. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, by a digital wallet on a user device and from a provider server via an intermediate server, a digital credential;
receiving, via a near-field communication (NFC) component of the user device and from a physical credential corresponding to the digital credential, credential information associated with the physical credential;
transmitting, by the digital wallet on the user device and to the provider server via the intermediate server, the credential information to verify the credential information;
receiving, by the digital wallet and from the provider server via the intermediate server, an indication that the physical credential is verified by the provider server; and
provisioning, by the digital wallet, the digital credential on a secure element of the user device.

2. The method of claim 1, wherein the credential information is received by the NFC component and provided directly to the secure element of the user device, bypassing a host processor of the user device.

3. The method of claim 1, further comprising receiving, on an interface of the digital wallet, a user input representing a password, wherein transmitting the credential information includes transmitting a cryptogram generated based on the password and at least some of the credential information.

4. The method of claim 3, wherein the password is encrypted by the secure element of the user device, and the cryptogram is generated by the secure element of the user device.

5. The method of claim 1, wherein the credential information includes at least one of a card number, an expiry date, and a credential cryptogram associated with physical credential.

6. The method of claim 1, further comprising:
before receiving the credential information, launching a digital wallet application on the user device; and
after provisioning the digital credential on the secure element, rendering a representation of the digital credential on the digital wallet application on the user device.

7. The method of claim 1, wherein the digital credential is inactive when it is received, and the digital credential is activated in response to receiving the indication that the physical credential is verified.

8. An electronic device comprising:
a memory; and
a processor circuit configured to:
receive, by a digital wallet on the electronic device and from a provider server via an intermediate server, a digital credential;
receive, via a near-field communication (NFC) component of the electronic device and from a physical credential corresponding to the digital credential, credential information associated with the physical credential;
transmit, by the digital wallet on the electronic device and to the provider server via the intermediate server, the credential information to verify the credential information;
receive, by the digital wallet and from the provider server via the intermediate server, an indication that the physical credential is verified by the provider server; and
provision, by the digital wallet, the digital credential on a secure element of the electronic device.

9. The electronic device of claim 8, wherein the credential information is received by the NFC component and provided directly to the secure element of the electronic device, bypassing a host processor of the electronic device.

10. The electronic device of claim 8, wherein the processor circuit is further configured to receive, on an interface of the digital wallet, a user input representing a password, wherein transmitting the credential information includes transmitting a cryptogram generated based on the password and at least some of the credential information.

11. The electronic device of claim 10, wherein the password is encrypted by the secure element of the electronic device, and the cryptogram is generated by the secure element of the electronic device.

12. The electronic device of claim 8, wherein the credential information includes at least one of a card number, an expiry date, and a credential cryptogram associated with physical credential.

13. The electronic device of claim 8, wherein the processor circuit is further configured to:
before receiving the credential information, launch a digital wallet application on the electronic device; and
after provisioning the digital credential on the secure element, render a representation of the digital credential on the digital wallet application on the electronic device.

14. The electronic device of claim 8, wherein the digital credential is inactive when it is received, and the digital credential is activated in response to receiving the indication that the physical credential is verified.

15. A non-transitory machine readable medium comprising instructions that, when executed by one or more processors on a user device, cause the one or more processors to perform operations comprising:
receiving, by a digital wallet on the user device and from a provider server via an intermediate server, a digital credential;
receiving, via a near-field communication (NFC) component of the user device and from a physical credential corresponding to the digital credential, credential information associated with the physical credential;
transmitting, by the digital wallet on the user device and to the provider server via the intermediate server, the credential information to verify the credential information;
receiving, by the digital wallet and from the provider server via the intermediate server, an indication that the physical credential is verified by the provider server; and
provisioning, by the digital wallet, the digital credential on a secure element of the user device.

16. The non-transitory machine readable medium of claim 15, wherein the credential information is received by the NFC component and provided directly to the secure element of the user device, bypassing a host processor of the user device.

17. The non-transitory machine readable medium of claim 15, further comprising receiving, on an interface of the digital wallet, a user input representing a password, wherein transmitting the credential information includes transmitting a cryptogram generated based on the password and at least some of the credential information.

18. The non-transitory machine readable medium of claim 17, wherein the password is encrypted by the secure element of the user device, and the cryptogram is generated by the secure element of the user device.

19. The non-transitory machine readable medium of claim 15, wherein the credential information includes at least one of a card number, an expiry date, and a credential cryptogram associated with physical credential.

20. The non-transitory machine readable medium of claim 15, further comprising:
before receiving the credential information, launching a digital wallet application on the user device; and
after provisioning the digital credential on the secure element, rendering a representation of the digital credential on the digital wallet application on the user device.
